(19) United States
(12) Patent Application Publication
(10) Pub. No.: US 2007/0192067 A1
(43) Pub. Date: Aug. 16, 2007

(54) Apparatus for Automatically Selecting Ring and Vibration Mode of a Mobile Communication Device

(75) Inventors: Shih-Fang Wong, Shenzhen (CN); Yu-Zhang Wen, Shenzhen (CN); Xiao-Lv Zhao, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/562,959

(22) Filed: Nov. 22, 2006

(30) Foreign Application Priority Data
Feb. 11, 2006 (CN) 200610033584.8

(51) Int. Cl. G06F 19/00

(52) U.S. Cl. 702/189; 702/127; 700/90

(57) ABSTRACT

An apparatus for automatically selecting alert option of a communication device is provided. The apparatus includes a noise detection unit for collecting a current ambient noise, and generating a quantified value of the current ambient noise according to the current ambient noise collected; and a central processing unit (CPU), including a detecting module for detecting the communication signal from the receiver, enabling the noise detection unit to perform the corresponding function, and determining a volume level of the current ambient noise according to the quantified value of the current ambient noise from the noise detection unit; and a controlling module for selecting a current alert option of the communication device according to the volume level of the current ambient noise, and controlling the ringing unit and the vibrating unit of the communication device to perform corresponding functions according to the alert option selected.

### BACKGROUND

1. Technical Field

The present invention relates to apparatuses and methods for selecting ring and vibration mode of a mobile communication device, and particularly to an apparatus and method for automatically selecting ring and vibration mode of a mobile communication device based on ambient noise.

2. General Background

When people use mobile communication devices, such as a mobile phone, they usually miss incoming calls or messages in a noisy environment, e.g., in a shopping mall, because the ring volume of the phone is too low to be heard. People may also interrupt others in a quiet environment, e.g., a library, because the ring volume is too loud.

Mobile phone manufacturers have introduced a function of changing alert options of the mobile phone. Users can preset a plurality of alert options for different environments such as outdoor, office, etc. Each alert option that corresponds to a certain level of ambient noise includes a ring tone type, a ring volume level, and a vibration mode, selectable by the user when the ambient noise environment changes.

Accordingly, users can select a proper alert option according to the level of the current ambient noise, which alerts the users of incoming calls or messages while not interrupting the others. But, according to this solution, users have to change the alert option manually, so there's a chance of forgetting to change the alert option selection.

What is needed, therefore, is an apparatus and method for automatically selecting the alert option, which can automatically select a proper alert option according to the ambient noise.

### SUMMARY

A communication device for automatically selecting a alert option is provided. The communication device includes a receiver for sending and receiving communication signals; a noise detection unit for collecting a current ambient noise, and generating a quantified value of the current ambient noise according to the current ambient noise collected; a ringing unit for performing a ring operation on the communication device; a vibrating unit for performing a vibration operation on the communication device; and a central processing unit (CPU), including a detecting module for detecting the communication signal from the receiver, enabling the noise detection unit to perform the corresponding function, and determining a volume level of the current ambient noise according to the quantified value of the current ambient noise from the noise detection unit; and a controlling module for selecting a current alert option of the communication device according to the volume level of the current ambient noise, and controlling the ringing unit and the vibrating unit to perform corresponding functions according to the alert option selected.

An apparatus for automatically selecting a alert option of a communication device is provided. The communication device includes a ringing unit for performing a ring operation and a vibrating unit for performing a vibration operation. The apparatus includes a noise detection unit for collecting a current ambient noise, and generating a quantified value of the current ambient noise according to the current ambient noise collected; and a central processing unit (CPU), including a detecting module for detecting the communication signal from the receiver, enabling the noise detection unit to perform the corresponding function, and determining a volume level of the current ambient noise according to the quantified value of the current ambient noise from the noise detection unit; and a controlling module for selecting a current alert option of the communication device according to the volume level of the current ambient noise, and controlling the ringing unit and the vibrating unit of the communication device to perform corresponding functions according to the alert option selected.

A method for automatically selecting a alert option of a communication device is also provided. The method includes the steps of: collecting a current ambient noise if the communication device receives a communication signal from an external electronic device, and generating a quantified value of the current ambient noise according to the current ambient noise collected; determining a volume level of the current ambient noise according to the quantified value of the current ambient noise; selecting a current alert option of the communication device according to the volume level of the current ambient noise; and performing a corresponding alert option control on the communication device according to the current alert option selected.

Other advantages and novel features will be drawn from the following detailed description with reference to the attached drawing, in which:

### BRIEF DESCRIPTION OF THE DRAWINGS

FIG. 1 is a schematic diagram of a hardware infrastructure of an apparatus for automatically selecting a alert option of a communication device in accordance with a preferred embodiment of the present invention;

FIG. 2 is a first preferred method for automatically selecting the alert option of the communication device of FIG. 1; and

FIG. 3 is a second preferred method for automatically selecting the alert option of the communication device of FIG. 1.

### DETAILED DESCRIPTION OF THE EMBODIMENT

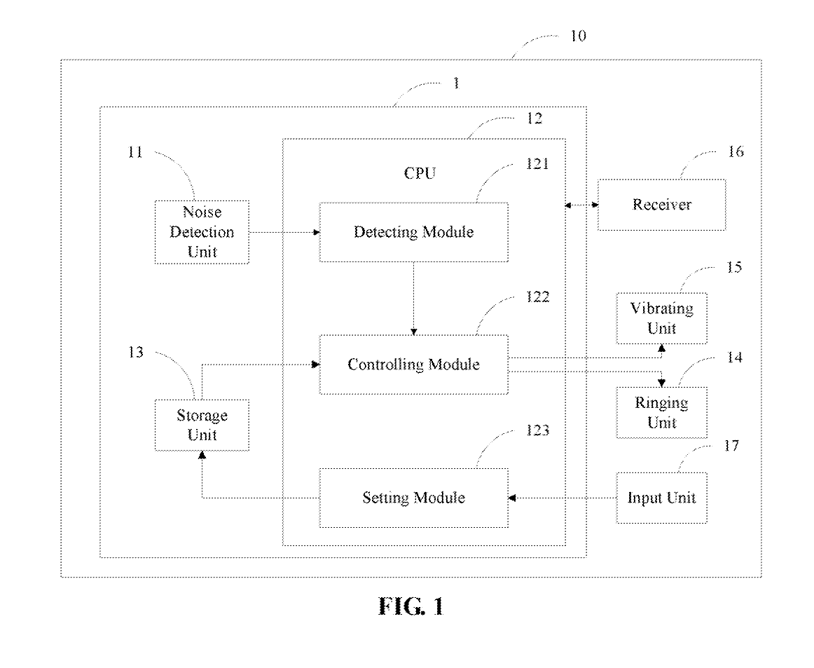

FIG. 1 is a schematic diagram of a hardware infrastructure of an apparatus for automatically selecting a alert option of a communication device in accordance with a preferred embodiment of the present invention. The apparatus 1 is incorporated into the communication device 10, and is capable of properly selecting an alert option according to an ambient noise automatically. The alert option includes a ring tone type, a ring volume level, and a vibration mode. The communication device 10 (e.g., a mobile phone) includes a receiver 16, an inputting unit 17, a ringing unit 14, and a vibrating unit 15. The receiver 16 is for sending and receiving communication signals from external electronic devices (e.g., other mobile phones). The inputting unit 17 is for generating an inputting signal in response to an operational input. The ringing unit 14 is for performing a ring operation on the communication device 10. The vibrating unit 15 is for performing a vibration operation on the communication device10.

The apparatus 1 includes a noise detection unit 11, a central processing unit (CPU) 12, and a storage unit 13. The noise detection unit 11 is for collecting a current ambient noise and generating a quantified value of the current ambient noise according to the current ambient noise. For simplicity, in this embodiment, a magnitude of the ambient noise is grouped into 5 levels, each level corresponding to a quantified value interval. For example, volume level ‘1’ of the ambient noise corresponds to a quantified value interval from ‘0’ DB (decibel) to ‘10’ DB, and volume level ‘2’ of the ambient noise corresponds to a quantified value interval from ‘11’ DB to ‘20’ DB, and so on.

The CPU 12 further includes a detecting module 121, a controlling module 122, and a setting module 123. The detecting module 121 is for detecting the communication signal from the receiver 16 and enabling the noise detection unit 11 to perform the corresponding function, and thereupon determining a volume level of the current ambient noise according to the quantified value of the current ambient noise received from the noise detection unit 11.

The setting module 123 is for setting the alert options (including a ring tone type, a ring volume level, and a vibration mode) corresponding to the volume levels of the ambient noise, in response to the inputting signals from the input unit 17, and storing the volume levels of the ambient noise and the alert options into the storage unit 13 correspondingly. For example, a volume level ‘1’ of the ambient noise corresponds to an alert option consisted of a lowest ring volume level ‘1’ or mute, a light music, and non-vibrating. A volume level 5 of the ambient noise corresponds to an alert option consisting of a highest ring volume level 5, a metal music type that is easier to be heard in a noise environment, and vibration mode ‘on’. Furthermore, the setting module 123 is for setting a volume level of a predetermined quantified value as a reference volume level, and setting a corresponding alert option as a reference alert option, and storing the reference volume level and the corresponding reference alert option into the storage unit 13. The alert options and the reference alert option also can be obtained from external medias such as communication networks, computers, etc.

The controlling module 122 is for selecting a current alert option of the communication device 10 according to the volume level of the current ambient noise, and controlling the ringing unit 14 and the vibrating unit 15 to perform corresponding functions according to the alert option selected. That is, the controlling module 122 obtains a corresponding alert option according to the volume level of the current ambient noise from the storage unit 13, and sets the alert option obtained as the current alert option of the communication device 10; or, the controlling module 122 calculates a value difference between the quantified value of the current ambient noise and the predetermined quantified value corresponding to the reference volume level obtained from the storage unit 13, and sets the alert option selected according to the value difference calculated as the current alert option of the communication device 10.

Therefore, by utilizing the apparatus 1, the communication device 10 (e.g., mobile phone) can automatically select the alert option according to the ambient noise, thereby, not only preventing users from missing incoming calls or messages in a relatively noisy environment, but also preventing the incoming calls or messages from interrupting others in a relatively quiet environment.

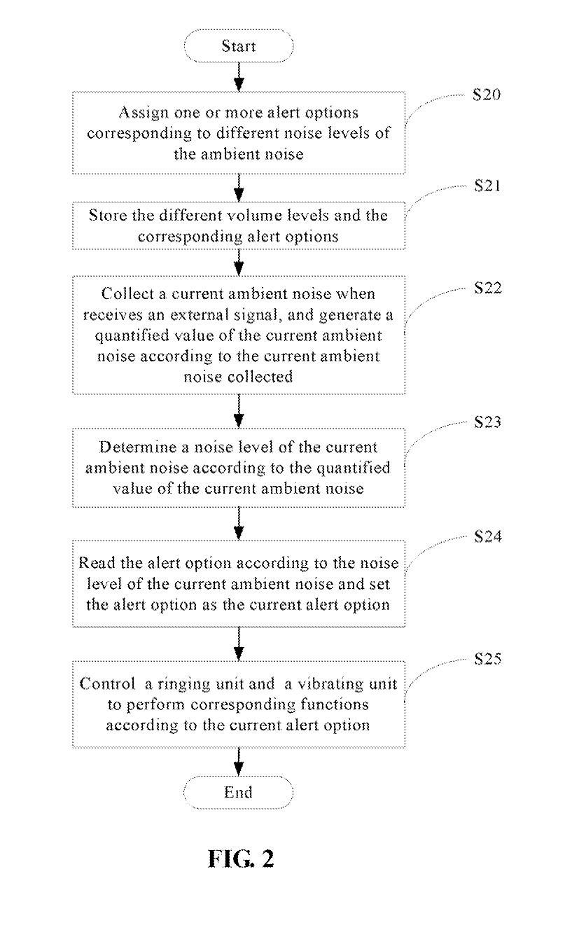

FIG. 2 is a flowchart of a first preferred method for automatically selecting the alert option of the communication device 10 of FIG. 1. In step S20, the setting module 123 assigns one or more alert options corresponding to different noise levels of the ambient noise based on the input signals received from the input unit 17.

In step S21, the controlling module 122 stores the different volume levels and the alert options from the setting module 123 or the external medias into the storage unit 13 correspondingly.

In step S22, the detecting module 121 enables the noise detection unit 11 to collect the current ambient noise when the detecting module 121 detects that the receiver 16 receives an external signal, and generates the quantified value of the current ambient noise according to the current ambient noise collected.

In step S23, the detecting module 121 determines the noise level of the current ambient noise according to the quantified value of the current ambient noise.

In step S24, the controlling module 122 reads the alert option according to the noise level of the current ambient noise from the storage unit 13, and sets the alert option as the current alert option of the communication device 10.

In step S25, the controlling module 122 controls the ringing unit 14 and the vibrating unit 15 to perform corresponding functions according to the current alert option.

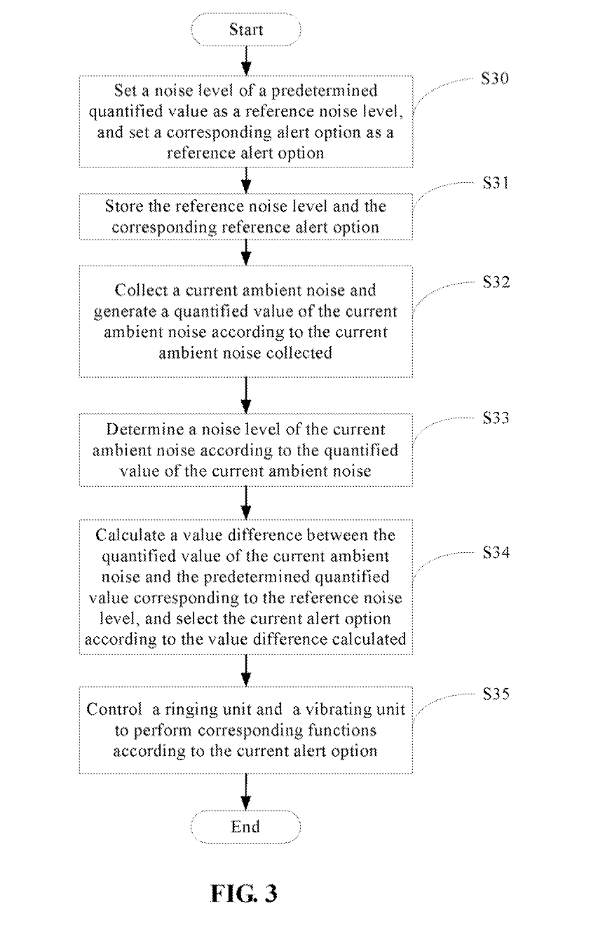

FIG. 3 is a flowchart of a second preferred method for automatically selecting the alert option of the communication device 10 of FIG. 1. In step S30, the setting module 123 sets the noise level of the predetermined quantified value as the reference noise level, and sets the alert option as a reference alert option correspondingly.

In step S31, the controlling module 122 stores the reference noise level and the reference alert option from the setting module 123 or the external media into the storage unit 13 correspondingly.

In step S32, the detecting module 121 enables the noise detection unit 11 to collect the current ambient noise when the detecting module 121 detects that the receiver 16 receives the external signal, and generates the quantified value of the current ambient noise according to the current ambient noise collected.

In step S33, the detecting module 121 determines the noise level of the current ambient noise according to the quantified value of the current ambient noise.

In step S34, The controlling module 122 calculates the value difference between the quantified value of the current ambient noise and the predetermined quantified value corresponding to the reference noise level obtained from the storage unit 13, and selects the current alert option according to the value difference calculated. For example, supposing that the reference noise level is set to correspond with the predetermined quantified value ‘30’ DB, and the reference alert option is consisted of a ring volume level ‘2’ and a vibration mode ‘off’ correspondingly. If the quantified value of the current ambient noise is greater than the predetermined quantified value of the reference volume level, e.g., the value difference calculated is ‘10’ DB, the controlling module 122 increases the ring volume level of the current alert option to a volume level ‘3’, and retains other options (e.g., the ring type, and the vibration mode) without changes. If the noise level of the current ambient noise is much greater than the reference volume level, e.g., the value difference calculated is ‘50’ DB, the controlling module 122 increases the ring volume level of the current alert option to a highest volume level of the communication device 10, change the ring tone type into metal music type, and switches the vibration mode of the current alert option from ‘off’ to ‘on’. In other words, the louder the ambient noise detected, the higher volume level of the alert option selected by the communication device 10, furthermore, the vibration mode of the alert option is selected to be ‘on’. Similarly, the quieter ambient noise detected, the lower the communication device 10 selects the volume level of the alert option, furthermore, the vibration mode of the alert option is selected to be ‘off’.

In step S35, the controlling module 122 controls the ringing unit 14 and the vibrating unit 15 to perform corresponding functions according to the current alert option.

Although the present invention has been specifically described on the basis of a preferred embodiment and preferred methods thereof, the invention is not to be construed as being limited thereto. Various changes or modifications may be made to the embodiment and method without departing from the scope and spirit of the invention.

What is claimed is:

1. A communication device for automatically selecting an alert option, the communication device comprising:
a receiver for sending and receiving communication signals;
a noise detection unit for collecting a current ambient noise, and generating a quantified value of the current ambient noise according to the current ambient noise collected;
a ringing unit for performing a ring operation on the communication device;
a vibrating unit for performing a vibration operation on the communication device; and
a central processing unit (CPU), comprising:
a detecting module for detecting the communication signal from the receiver, enabling the noise detection unit to perform the corresponding function, and determining a volume level of the current ambient noise according to the quantified value of the current ambient noise from the noise detection unit; and
a controlling module for selecting a current alert option of the communication device according to the volume level of the current ambient noise, and controlling the ringing unit and the vibrating unit to perform corresponding functions according to the alert option selected.

2. The communication device according to claim 1, wherein the CPU further comprises a setting module for setting alert options each corresponding to a different volume level of the ambient noise.

3. The communication device according to claim 2, further comprising a storage unit for storing the different volume levels and the corresponding alert options set by the setting module.

4. The communication device according to claim 3, wherein the controlling module is further configured for obtaining a corresponding alert option according to the volume level of the current ambient noise from the storage unit, and setting the alert option obtained as the current alert option of the communication device.

5. The communication device according to claim 1, wherein the CPU further comprises a setting module for setting a volume level of a predetermined quantified value as a reference volume level, and setting a corresponding alert option as a reference alert option.

6. The communication device according to claim 5, further comprising a storage unit for storing the reference volume level and the corresponding reference alert option set by the setting module.

7. The communication device according to claim 6, wherein the controlling module is further configured for calculating a value difference between the quantified value of the current ambient noise and the predetermined quantified value corresponding to the reference volume level obtained from the storage unit, and setting the alert option selected according to the value difference calculated as the current alert option of the communication device.

8. The communication device according to claim 1, wherein the alert option corresponding to the volume level of the ambient noise is obtained from an external media.

9. A method for automatically selecting an alert option of a communication device, the method comprising the steps of:
collecting a current ambient noise if the communication device receives a communication signal from an external electronic device, and generating a quantified value of the current ambient noise according to the current ambient noise collected;
determining a volume level of the current ambient noise according to the quantified value of the current ambient noise;
selecting a current alert option of the communication device according to the volume level of the current ambient noise; and
performing a corresponding alert option control on the communication device according to the current alert option selected.

10. The method according to claim 9, wherein the selecting step further comprises the steps of:
setting one or more alert options each corresponding to the volume level of the ambient noise;
providing a storage unit for storing the different volume levels and the corresponding alert options; and
obtaining a alert option according to the volume level of the current ambient noise from the storage unit and setting the alert option as the current alert option.

11. The method according to claim 9, wherein the selecting step further comprises the steps of:
setting a volume level of a predetermined quantified value as a reference volume level, and setting a corresponding alert option as a reference alert option;
providing a storage unit for storing the reference volume level and the corresponding reference alert option; and
calculating a value difference between the quantified value of the current ambient noise and the predetermined quantified value corresponding to the reference volume level obtained from the storage unit, and setting the alert option selected according to the value difference calculated as the current alert option.

12. The method according to claim 9, wherein the alert options according to the volume levels of the ambient noise are obtained from an external media.

13. An apparatus for automatically selecting a alert option of a communication device, the communication device comprising a ringing unit for performing a ring operation and a vibrating unit for performing a vibration operation, the apparatus comprising:
a noise detection unit for collecting a current ambient noise, and generating a quantified value of the current ambient noise according to the current ambient noise collected; and
a central processing unit (CPU), comprising:
a detecting module for detecting the communication signal from the receiver, enabling the noise detection unit to perform the corresponding function, and determining a volume level of the current ambient noise according to the quantified value of the current ambient noise from the noise detection unit; and
a controlling module for selecting a current alert option of the communication device according to the volume level of the current ambient noise, and controlling the ringing unit and the vibrating unit of the communication device to perform corresponding functions according to the alert option selected.

14. The apparatus according to claim 13, wherein the CPU further comprises a setting module for setting alert options each corresponding to a different volume level of the ambient noise.

15. The apparatus according to claim 14, further comprising a storage unit for storing the different volume levels and the corresponding alert options set by the setting module.

16. The apparatus according to claim 15, wherein the controlling module obtains a corresponding alert option according to the volume level of the current ambient noise from the storage unit, and sets the alert option obtained as the current alert option of the communication device.

17. The apparatus according to claim 13, wherein the CPU further comprises a setting module for setting a volume level of a predetermined quantified value as a reference volume level, and setting a corresponding alert option as a reference alert option.

18. The apparatus according to claim 17, further comprising a storage unit for storing the reference volume level and the corresponding reference alert option set by the setting module.

19. The apparatus according to claim 18, wherein the controlling module further calculates a value difference between the quantified value of the current ambient noise and the predetermined quantified value corresponding to the reference volume level obtained from the storage unit, and sets the alert option selected according to the value difference calculated as the current alert option of the communication device.

20. The apparatus according to claim 13, wherein the alert option corresponding to the volume level of the ambient noise is obtained from an external media.
